(19) United States
(12) Patent Application Publication
(10) Pub. No.: US 2025/0145242 A1
(43) Pub. Date: May 8, 2025

(54) SWITCH ASSEMBLY FOR A HANDLEBAR FOR A TWO-WHEELER

(71) Applicants: UNO MINDA LIMITED, Distt. Gurgaon (IN); HARLEY-DAVIDSON MOTOR COMPANY, INC., Milwaukee, WI (US)

(72) Inventors: Kumar Desh DEEPAK, Distt. Gurgaon (IN); Rahul SAHNI, Distt. Gurgaon (IN); Anish GULATI, Distt. Gurgaon (IN); Piyush TIWARI, Distt. Gurgaon (IN); Seth FRYE, Wauwatosa, WI (US); Nicholas PAUL, Wauwatosa, WI (US)

(73) Assignees: UNO MINDA LIMITED, Distt. Gurgaon (IN); HARLEY-DAVIDSON MOTOR COMPANY, INC., Milwaukee, WI (US)

(21) Appl. No.: 18/935,301

(22) Filed: Nov. 1, 2024

(30) Foreign Application Priority Data
Nov. 2, 2023 (IN) 202311074662

(51) Int. Cl. B62K 11/14; B62K 23/04

(52) U.S. Cl. CPC B62K 11/14; B62K 23/04

(57) ABSTRACT

The present disclosure relates to a switch assembly (104, 204) of a handlebar assembly (100) of a two-wheeler. The switch assembly (104, 204) includes a first portion (110), a second portion, and a lock assembly (114). The first portion (110) defines a base (150), and the second portion is disposed to cover the switch assembly (104, 204). The lock assembly (114) is adapted to secure the first portion (110). The lock assembly (114) includes a first bracket (140) mounted on an end of the first portion (110), a second bracket (142, 242) mounted on an end of the first 10 portion (110) and a clamping element (144, 244) pivotally coupled with the first bracket (140) and adapted to lock with the second bracket (142, 242) to secure the switch assembly (104, 204) to the handlebar assembly (100).

### FIELD OF THE DISCLOSURE

The present disclosure generally relates to a handlebar assembly of a two-wheeler, and more particularly, to a switch assembly disposed on the handlebar assembly of the two-wheeler.

### BACKGROUND

The following description includes information that may be useful in understanding the present invention. It is not an admission that any of the information provided herein is prior art or relevant to the presently claimed invention, or that any publication specifically or implicitly referenced is prior art.

A handlebar of a two-wheeler is used to provide easy access to controls of the two-wheeler to a rider and can further be used to steer the two-wheeler in a required direction. The handlebar usually has of a horizontal bar which is mounted on a steering column of the two-wheeler.

A switch assembly is used to control electrical components of the two-wheeler, such as headlights, turning indicators, horns, are generally mounted on the handlebar of a two-wheeler via one or more fasteners. The switch assembly is fixed on the handlebar via screws or fasteners that require special tools for assembly or disassembly of the same. In case the switch assembly is not fastened securely, the switch may move, rotate, or completely detach from the two-wheeler while the two-wheeler is moving. Further, the movement or rotation of the switch assembly from the handlebar may cause inaccurate operation of switches, distraction for the rider, and delayed or faulty response to changing route conditions. The complete detachment of the switch assembly from the handlebar may cause the rider to completely lose the ability to control crucial functionality of various components of the two-wheeler.

In addition, a plurality of wires which connects the switch assembly to the electrical components pass through the handlebar and gets continuously rubbed against the accelerator thereby leading to the wear and tear of the wires. The possibility of the wires getting damaged is very high. Also, the wear and tear of the wires can result in short circuits and poor connections which may cause loss of functionality of the switches on the switch assembly, thus compromising the two-wheeler'operation and safety.

Therefore, the switch assembly for the handlebar of the two-wheeler is desired that prevents the wear and tear of the wires and is easy to assemble and disassemble without affecting the overall operating characteristics of the accelerator or other operating parameters of the two-wheeler.

The above-mentioned drawbacks/difficulties/disadvantages of the conventional techniques are explained just for exemplary purposes and this disclosure and description mentioned below would never limit its scope only such a problem. A person skilled in the art may understand that this disclosure and below mentioned description may also solve other problems or overcome the above-mentioned drawbacks/disadvantages of the conventional arts which are not explicitly captured above.

### SUMMARY

This summary is provided to introduce a selection of concepts, in a simplified format, that are further described in the detailed description of the invention. This summary is neither intended to identify key or essential inventive concepts of the invention nor intended to determine the scope of the invention.

The present disclosure relates to a switch assembly disposed on a handlebar assembly of a two-wheeler. The switch assembly is used for the actuation of a plurality of tasks for the operation of the two-wheeler. The switch assembly is a screwless movable hinge-type wire clamp with a stopper which further includes a protection cover.

The present disclosure further relates to the switch assembly for a handlebar assembly of a two-wheeler. The switch assembly includes a first portion defining a base of the switch assembly, a second portion adapted to cover the switch assembly, and a lock assembly adapted to secure the first portion. The lock assembly includes a first bracket mounted on the end of the first portion, a second bracket mounted on the end of the first portion, and a clamping element pivotally coupled with the first bracket and adapted to lock with the second bracket to secure the switch assembly to the handlebar assembly. The clamping element includes a first lock to engage with a portion of the second bracket. In addition, the second bracket includes a second lock adapted to engage the first lock of the clamping element.

The switch assembly eliminates the use of fasteners and additional assembly components for the installation of the switch assembly with the handlebar of the two-wheeler. Further, the switch assembly includes the clamping element having the channels to route the wires of the switch assembly to prevent any breakage or any wear and tear of the wires thereby prolonging the life of the switch assembly. In addition, the snap fitting mechanism for locking and unlocking the clamping element facilitates an ease of assembly and disassembly of the switch assembly thereby eliminating the need for any adjustments to be made in the handlebar during assembly and disassembly. In addition, the switch assembly is prone to vibrations from the two-wheeler and remains intact due to the limiting element.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a perspective view of a handlebar assembly of a two-wheeler in an unlocked configuration, according to an embodiment of the present disclosure;

FIG. 2 illustrates a perspective view of the handlebar assembly of a two-wheeler in a locked configuration, according to an embodiment of the present disclosure;

FIG. 3 illustrates a sectional view of a switch assembly, according to an embodiment of the present disclosure;

FIG. 4 illustrates a perspective view of the switch assembly mounted on the handlebar assembly, according to an embodiment of the present disclosure;

FIG. 5 illustrates a perspective view of the switch assembly, according to an embodiment of the present disclosure;

FIG. 6 illustrates a perspective view of a first bracket, according to an embodiment of the present disclosure;

FIG. 7 illustrates a perspective view of a clamping element, according to an embodiment of the present disclosure;

FIG. 8 illustrates a perspective view of a second bracket, according to an embodiment of the present disclosure;

FIG. 9 illustrates a perspective view of an embodiment of the switch assembly mounted on the handlebar assembly, according to an embodiment of the present disclosure;

FIG. 10 illustrates a side-sectional view of the embodiment of the switch assembly, according to an embodiment of the present disclosure;

FIG. 11 illustrates an embodiment of a clamping element of the switch assembly, according to an embodiment of the present disclosure; and

FIG. 12 illustrates an embodiment of the second bracket of the switch assembly, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Unless otherwise defined, all terms, and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present invention will be described below in detail with reference to the accompanying drawings.

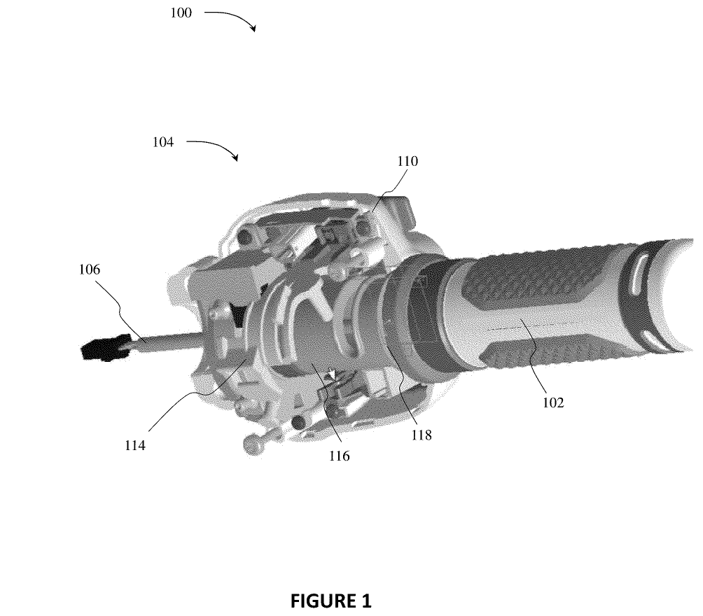

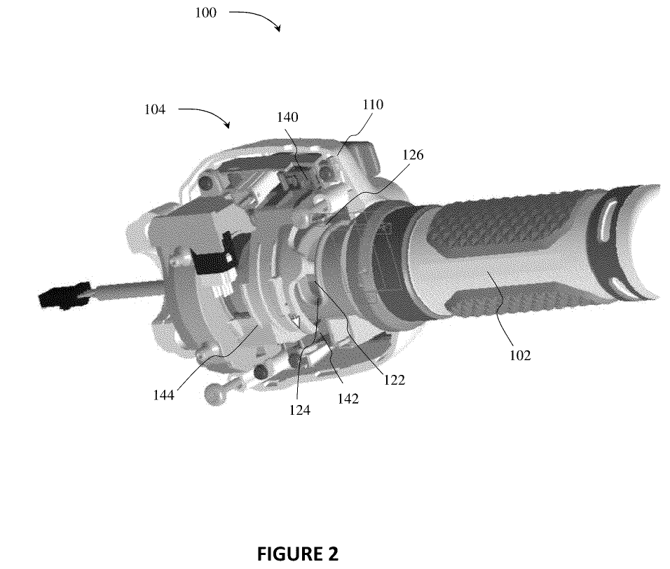

Referring to FIG. 1 and FIG. 2 a handlebar assembly 100 for a two-wheeler (not shown) is shown, the handlebar assembly 100 facilitates the acceleration and manoeuvring of the two-wheeler by the rider/user. Specifically, FIG. 1 illustrates a perspective view of the handlebar assembly 100 of the two-wheeler in an unlocked configuration. FIG. 2 illustrates a perspective view of the handlebar assembly 100 of a two-wheeler in a locked configuration.

The handlebar assembly 100 includes an accelerator 102 to facilitate the throttling of the two-wheeler, and a switch assembly 104 to facilitate the positioning of the one or more switches. In addition, the switch assembly 104 includes an accelerator cable 106 coupled with the accelerator 102 to control the opening and closing of a throttle body and facilitate the acceleration and retardation of the two-wheeler. In addition, the switch assembly 104 may include a plurality of switches to facilitate the function of the two-wheeler. The switches may include a horn switch, an indicator switch, a light switch, a light beam switch and each having one or more wires passing through the switch assembly 104 to the other parts of the two-wheeler.

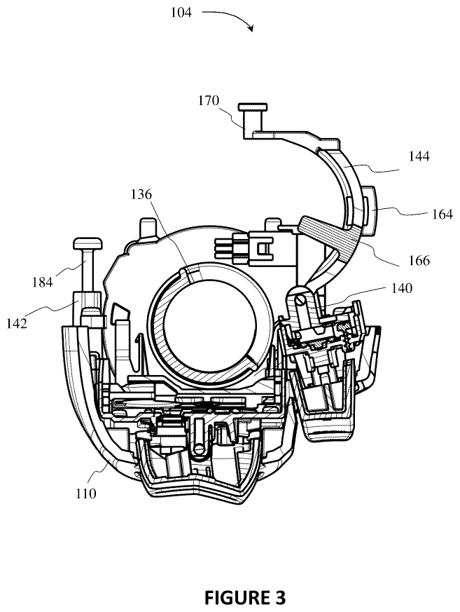

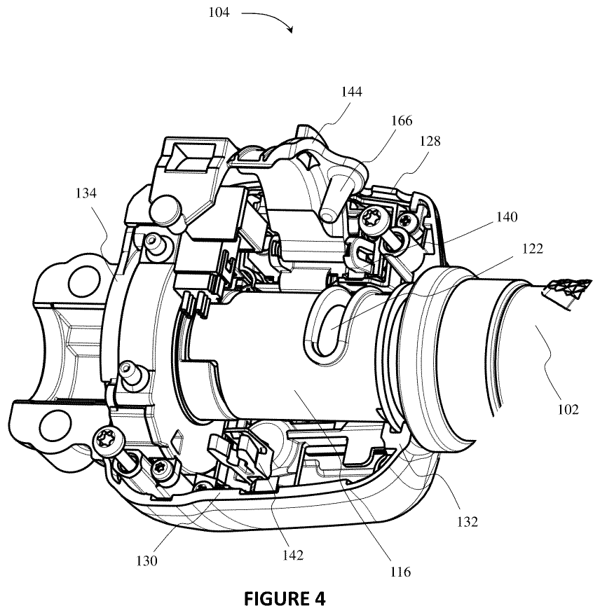

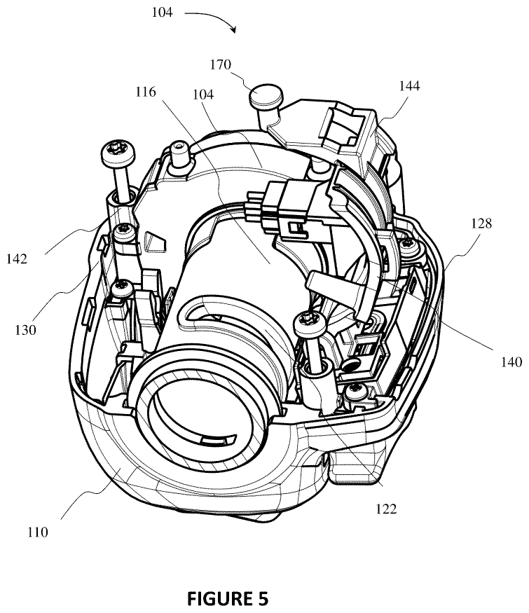

Referring to FIG. 3 to FIG. 5 different perspective views of the switch assembly 104 are shown. FIG. 3 illustrates a sectional view of the switch assembly 104. FIG. 4 illustrates a perspective view of the switch assembly 104 mounted on the handlebar assembly 100. FIG. 5 illustrates a perspective view of the switch assembly 104.

The switch assembly 104 may include a first portion 110 defining a base of the switch assembly 104, and a second portion (not shown in figures) adapted to couple with the first portion 110 such that the handlebar assembly 100 is sandwiched between the first portion 110 and the second portion. In addition, the switch assembly 104 includes a lock assembly 114 to facilitate the locking of the first portion 110 and facilitates a secure arrangement between the first portion 110, the second portion, and the handlebar assembly 100. In an embodiment, the second portion may be defined as a back cover. In addition, the second portion is adapted to cover the switch assembly 104. The switch assembly 104 to facilitate the covering of the switch assembly 104.

Further, the handlebar assembly 100 includes a throttle grip 116 and is adapted to rotatably rest between the first portion 110 and the second portion. The throttle grip 116 includes a first end 118 securely coupled with the accelerator 102, such that the rotation of the accelerator 102 enables a rotation of the throttle grip 116. Further, the throttle grip 116 includes a second end (not shown) disposed opposite to the first end 118 and adapted to rest within the switch assembly 104.

Additionally, the throttle grip 116 includes an elongated slot 122 extending along an outer surface of the throttle grip 116. As shown, the elongated slot 122 extends radially along a circumference of the outer surface of the throttle grip 116. The elongated slot 122 includes a first end 124 and a second end 126 disposed opposite to the first end 124. In an embodiment, the switch assembly 104 includes a provision to dispose of the throttle grip 116 of the handlebar assembly 100. The throttle grip 116 is adapted to rotatably rest between the first portion 110 and the second portion.

As shown, the first portion 110 of the switch assembly 104 defines an enclosure having a first longitudinal sidewall 128, a second longitudinal sidewall 130 disposed parallel and spaced apart from the first longitudinal sidewall 128, a first lateral sidewall 132 adapted to extend between the first longitudinal sidewall 128 and the second longitudinal sidewall 130. In addition, the first portion 110 includes a second lateral sidewall 134 disposed spaced apart and disposed parallel from the first lateral sidewall 132. The second lateral sidewall 134 is adapted to rest between the first longitudinal sidewall 128 and the second longitudinal sidewall 130. In addition, the first lateral sidewall 132 and the second lateral sidewall 134 include a central cavity 136 defining a hole to receive the handlebar assembly 100. The central cavity 136 defines a semi-circular cut-out portion extending inwardly from the two lateral sidewalls 132, 134. The central cavity 136 of the two sidewalls 132, 134 facilitates the resting of the throttle grip 116 in the central cavity 136. In an example, the central cavity 136 of the two sidewalls 132, 134 may include a bearing to facilitate the rotational coupling of the throttle grip 116 within the central cavity 136.

Further, the first portion 110 includes a first bracket 140 of the locking assembly 114 mounted on an end of the first portion 110 proximate to the first longitudinal sidewall 128, a second bracket 142 of the locking assembly 114 mounted on an end of the first portion 110 proximate to the second longitudinal sidewall 130, and a clamping element 144 pivotally coupled with the first bracket 140 and adapted to lock via a snap-fit with the second bracket 142.

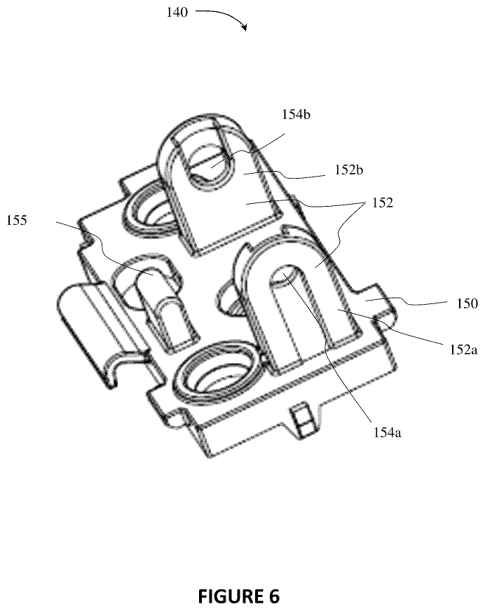

Referring to FIG. 6, a perspective view of the first bracket 140 is shown. The first bracket 140 includes the base 150 adapted to couple with the first portion 110 of the switch assembly 104. In addition, the first bracket 140 includes a pair of sidewalls 152 extending outwardly from the base 150 and disposed spaced apart from one another. In an example, the pair of sidewalls 152 defines a flat-shaped configuration. In an example, the pair of sidewalls 152 includes a first sidewall 152a extending outwardly from the base 150 of the first bracket 140 and a second sidewall 152b disposed parallel to and spaced apart from the first sidewall 152a and extending outwardly from the base 150 of the first bracket 140. The first sidewall 152a includes a hole 154 extending along a thickness of the first sidewall 152a, and the second sidewall 152b includes a hole 154b aligned with the hole 154a of the first sidewall 152a. The two holes 154a, 154b of the two sidewalls 152a, 152b facilitate the pivotal coupling of the clamping element 144 with the first bracket 140.

In addition, the first bracket 140 includes a stopper 155 to restrict the movement of the clamping element 144 beyond a predetermined degree of rotation towards the first portion 110 of the switch assembly 104. The stopper 155 defines a protruding portion extending outwardly from the base 150 of the first bracket 140 and the stopper 155 is disposed in a staggered arrangement and disposed spaced apart from the two sidewalls 152a, 152b. In an embodiment, the first bracket 140 and the second bracket 142 is integrated into the first portion 110. In another embodiment, the first bracket 140 is fastened to the first portion 110. In an example, the first bracket 140 is made of a moulding process such as injection moulding, diecasting, or any other 3-d printing technique. In another example, the first bracket 140 is made of a plastic grade.

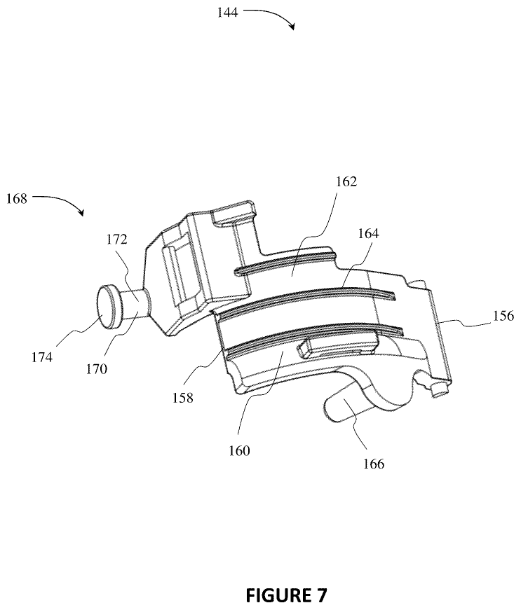

Referring to FIG. 7, a perspective view of the clamping element 144 of the lock assembly 114 is shown. The clamping element 144 of the lock assembly 114 facilitates the locking and unlocking of the first portion 110. The clamping element 144 is pivotally coupled with the first bracket 140 and adapted to lock or snap-fit with the second bracket 142 to secure the switch assembly 104 to the handlebar assembly 100. In addition, the clamping element 144 includes a first end 156 adapted to pivotally couple with the first bracket 140, a second end 158 adapted to lock and unlock with the second bracket 142 and defining a distal end of the second bracket 142, and an arc section 160 extending from the first end 156 to the second end 158.

In addition, the first end 156 of the clamping element 144 includes a pair of pins adapted to pivotally couple to the pair of holes 154a, 154b of the respective sidewalls 152 of the first bracket 140. In addition, the arc section 160 defines a sector having a curved portion 162 extending from the first end 156 to the second end 158. In addition, the arc section 160 includes at least one channel 164 disposed along the curved portion 162 of the arc section 160. The channel 164 is adapted to receive a plurality of wires (not shown) adapted to pass through the switch assembly 104 and prevent any contact between the wires and the throttle grip 116 thereby preventing any wear and tear of the wires in the switch assembly 104.

In addition, the clamping element 144 includes a protruding member 166 extending axially inward from the arc section 160. The protruding member 166 is adapted to rest inside the elongated slot 122 of the throttle grip 116. The protruding member 166 is adapted to lock the throttle grip 116 along the two ends such that the protruding member 166 abuts the first end 124 of the elongated slot 122 to restrict the movement of the throttle grip 116 along a first direction of rotation and the protruding member 166 abuts the second end 126 of the elongated slot 122 to restrict the movement of the throttle grip 116 along a second direction of rotation. The constraining of the motion of the throttle grip 116 further constrains/restricts the motion of the accelerator 102 thereby limiting the minimum and maximum throttle of the two-wheeler.

Further, the second end 158 of the clamping element 144 includes a first lock 168 to engage with a portion of the second bracket 142. As shown, the first lock 168 includes a pin clamp 170 protruding axially outward from the second end 158 and adapted to snap fit with the second bracket 142. The pin clamp 170 includes a neck portion 172 to clamp with the second bracket 142 to facilitate the retaining of the first lock 168 within the second bracket 142 and a head portion 174 defining an elongated portion to receive a user input to operate the clamp 170 for clamping the neck portion 172 with the second bracket 142.

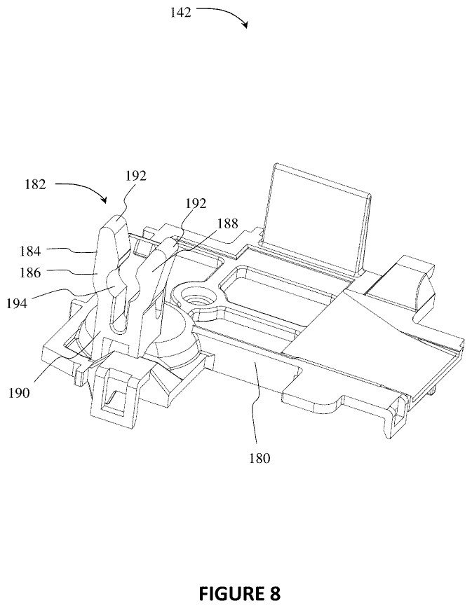

Referring to FIG. 8, a perspective view of the second bracket 142 of the lock assembly 114 is shown. The second bracket 142 includes a frame 180 having a plurality of members to facilitate the mounting of the second bracket 142 proximate to the second longitudinal sidewall 130 the first portion 110. Additionally, the frame 180 includes a second lock 182 adapted to engage with the first lock 168 of the clamping element 144. The second lock 182 includes a coupler 184 extending outwardly from the frame 180.

The coupler 184 includes a first arm 186 extending outwardly from the frame 180 and a second arm 188 disposed parallel and spaced apart from the first arm 186. The first arm 186 and the second arm 188 are joined along respective first ends 190 and are disposed spaced apart along respective opposite ends 192. In addition, the second lock 182 includes a central portion 194 defining an opening extending between the first arm 186 and the second arm 188. The opening facilitates the receiving of the neck portion 172 of the clamping element 144.

Further, the opposite ends 192 of the two arms 186, 188 may be separated to facilitate the entry and exit of the neck portion 172 and snap-fit with the central portion 194 of the second lock 182. In addition, the portion of the two arms 186, and 188 disposed proximate to the opposing ends 192 are tapered having a reduced area of cross-section along the opposing ends 192 to facilitate the entry of the neck portion 172 of the clamping element 144 and restrict the exit of the clamping element 144. In an embodiment, the second bracket 142 is integrated into the first portion 110. In another embodiment, the second bracket 142 is fastened to the first portion 110. In an example, the second bracket 142 is made of a moulding process such as injection moulding, diecasting, or any other 3-d printing technique. In an example, the second bracket 142 is made of a plastic grade material.

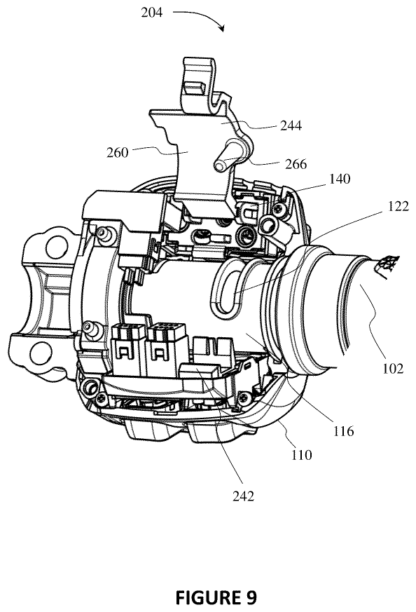

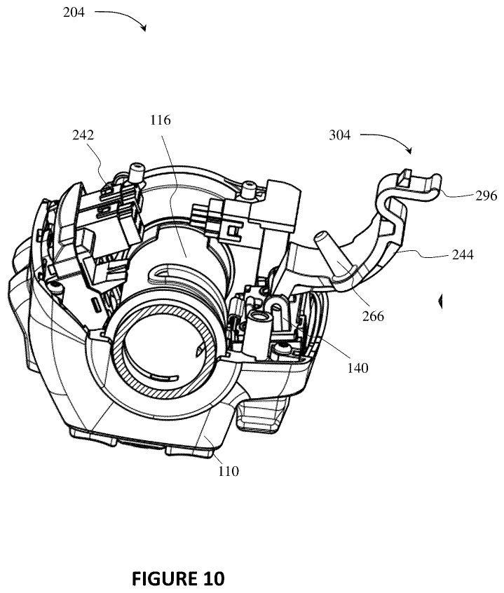

Referring FIG. 9 to FIG. 10, another embodiment of the switch assembly 204 is shown. Specifically, FIG. 9 illustrates a perspective view of an embodiment of the switch assembly 204 mounted on the handlebar assembly 100.

FIG. 10 illustrates a side-sectional view of the embodiment of the switch assembly 204. The switch assembly 204 is shown. The switch assembly 204 is similar to the switch assembly 104 except for a second bracket 242 of the lock assembly 114 and a clamping element 244 of the lock assembly 114 are different from the second bracket 142 of the lock assembly 114 of the switch assembly 204 and a clamping element 144 of the lock assembly 114 of the switch assembly 204. For clarity and brevity, all the elements of the switch assembly 204 are provided with the same elements having the same reference numerals as that of the switch assembly 104.

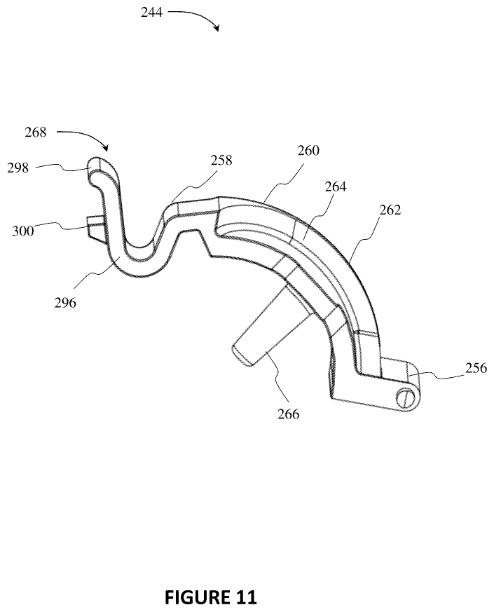

Referring to FIG. 11, an embodiment of the clamping element 244 of the lock assembly 114 of the switch assembly 204 is shown. The clamping element 244 facilitates the locking and unlocking of the first portion 110. The clamping element 244 is pivotally coupled with the first bracket 140 and adapted to lock or snap-fit with the second bracket 242 to secure the switch assembly 204 to the handlebar assembly 100. In addition, the clamping element 244 includes a first end 256 adapted to pivotally couple with the first bracket 140, a second end 258 adapted to lock and unlock with the second bracket 242 and defining a distal end of the second bracket 242, and an arc section 260 extending from the first end 256 to the second end 258.

In addition, the first end 256 of the clamping element 244 includes a pair of pins adapted to pivotally couple to the pair of holes 154a, 154b of the sidewalls 152 of the first bracket 140. In addition, the arc section 260 defines a sector having a curved portion 262 extending from the first end 256 to the second end 258. In addition, the arc section 260 includes at least one channel 264 disposed along the curved portion 262 of the arc section 260. The channel 264 is adapted to receive a plurality of wires (not shown) adapted to pass through the switch assembly 204 and prevent any contact between the wires and the throttle grip 116 thereby preventing any wear and tear of the wires in the switch assembly 204.

In addition, the clamping element 244 includes a protruding member 266 extending axially inward from the arc section 260. The protruding member 266 is adapted to rest inside the elongated slot 122 of the throttle grip 116. The protruding member 266 is adapted to lock the throttle grip 116 along the two ends such that the protruding member 266 abuts the first end 124 of the elongated slot 122 to restrict the movement of the throttle grip 116 along a first direction of rotation and the protruding member 266 abuts the second end 126 of the elongated slot 122 to restrict the movement of the throttle grip 116 along a second direction of rotation. The constraining of the motion of the throttle grip 116 further constrains/restricts the motion of the accelerator 102 thereby limiting the minimum and maximum throttle of the two-wheeler.

Further, the second end 258 of the clamping element 244 includes a first lock 268 to engage with a portion of the second bracket 242. The first lock 268 is disposed along the second end 258 and includes a flexible U-shaped clamp 296, and a lever 298 extending from a distal end of the flexible U-shaped clamp 296 and adapted to receive a user input to operate the flexible U-shaped clamp 296. In addition, the flexible U-shaped clamp 296 includes a locking element 300 adapted to engage with the second bracket 242 to facilitate the locking and actuation of the snap-fit of the flexible U-shaped clamp 296 in the second bracket 242. In an embodiment, the flexible U-shaped clamp 296 of the first lock 268 includes the locking element 300 to clamp with the second bracket 242 with the clamping element 244.

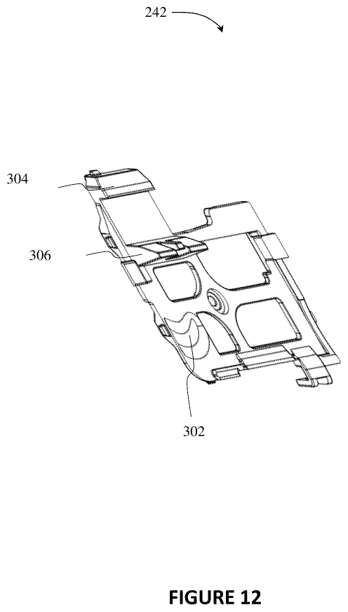

Referring to FIG. 12 illustrates an embodiment of the second bracket 242 of the lock assembly 114 of the switch assembly 204. The second bracket 242 includes a frame 302 having a plurality of members to facilitate the mounting of the second bracket 242 proximate to the second longitudinal sidewall 130 the first portion 110. Additionally, the frame 302 includes a second lock 304 adapted to engage with the first lock 268 of the clamping element 244. In addition, the second bracket 242 includes a limiting element 306 coupled to the frame 302 to restrict the downward movement of the flexible U-shaped clamp 296 and prevent any vibration or accidental opening of the flexible U-shaped clamp 296. In an embodiment, the first bracket 140 and the second bracket 242 is integrated into the first portion 110. In another embodiment, the second bracket 242 is fastened to the first portion 110. In an example, the second bracket 242 is made of a moulding process such as injection moulding, diecasting, or any other 3-d printing technique.

The switch assembly 104, and 204 eliminate the use of fasteners and additional assembly components for installation of the switch assembly 104, 204 with the handlebar assembly 100 of the two-wheeler. Further, the switch assembly 104, 204 includes the clamping element 144, 244 the lock assembly 114 having the channels 164, 264 to route the wires of the switch assembly 104, 204 to prevent any breakage or any wear and tear of the wires thereby prolonging the life of the switch assembly 104, 204. In addition, the snap fitting mechanism for locking and unlocking the clamping element 144, 244 facilitates an ease of assembly and disassembly of the switch assembly 104, 204 thereby eliminating the need for any adjustments to be made in the handlebar assembly 100 while assembly and disassembly. In addition, the switch assembly 104, 204 is prone to vibrations from the two-wheeler and remains intact due to the limiting element 306.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A switch assembly (104, 204) for a handlebar assembly (100) of a two-wheeler, the switch assembly (104, 204) comprising:
a first portion (110) defining a base of the switch assembly (104, 204);
a second portion adapted to cover of the switch assembly (104, 204); and
a lock assembly (114) adapted to secure the first portion (110), the lock assembly (114) comprising:
a first bracket (140) mounted on an end of the first portion (110);
a second bracket (142, 242) mounted on an end of the first portion (110); and
a clamping element (144, 244) pivotally coupled with the first bracket (140) and adapted to lock with the second bracket (142, 242) to secure the switch assembly (104, 204) to the handlebar assembly (100),
wherein
the clamping element (144, 244) includes a first lock (168, 268) to engage with a portion of the second bracket (142, 242); and
the second bracket (142, 242) includes a second lock (182, 304) adapted to engage the first lock (168, 268) of the clamping element (144, 244).

2. The switch assembly (104, 204) as claimed in claim 1, comprising a provision to dispose a throttle grip (116) of the handlebar assembly (100), wherein the throttle grip (116) is adapted to rotatably rest between the first portion (110) and the second portion.

3. The switch assembly (104, 204) as claimed in claim 1, wherein the first bracket (140) comprising:
the base (150);
a pair of sidewalls (152a, 152b) extending upwardly from the base (150) having a pair of holes (154a, 154b) to facilitate the pivotal coupling of the clamping element (144, 244); and
a stopper (155) to restrict the movement of the clamping element (144, 244) beyond a predetermined degree of rotation towards the first portion (110).

4. The switch assembly (104, 204) as claimed in claim 1, wherein the clamping element (144, 244) further comprising:
a first end (156, 256) having a pair of pins adapted to pivotally couple to the pair of holes (154a, 145b) of the pair of sidewalls (152a, 152b) of the first bracket (140);
an arc section (160, 260) extending from the first end (156, 256); and
a second end (158, 258) extending from a distal end of the arc section (160, 260), the second end (158, 258) comprises at least one of:
a flexible U-shaped clamp (296) of the first lock (268) having a locking element (300) to clamp with the second bracket (242) with the clamping element (244), and a lever (298) extending from the distal end of the flexible U-shaped clamp (296) and adapted to receive a user input to operate the flexible U-shaped clamp (296); and
a pin clamp (170) of the first lock (168) protruding axially outwardly from the second end (158) having a neck portion (172) to clamp with the second bracket (142) with the clamping element (144).

5. The switch assembly (104, 204) as claimed in claim 4, wherein the clamping element (144, 244) includes a protruding member (166, 266) extending axially inward from the arc section (160, 260), wherein the protruding member (166, 266) is adapted to lock the throttle grip (116).

6. The switch assembly (104, 204) as claimed in claim 5, wherein the clamping element (144, 244) includes at least one channel (164, 264) disposed along a curved surface of the arc section (160, 260) and adapted to
receive a plurality of wires, and
prevent contact between the wires and the throttle grip (116).

7. The switch assembly (204) as claimed in claim 4, wherein the second bracket (242) comprises:
a frame (302) having the second lock (304); and
a limiting element (306) coupled to the frame (302) and to restrict the downward movement of the flexible U-shaped clamp (296) therebeyond;
wherein
the second lock (304) and the limiting element (306) are adapted to prevent relative movement of the flexible U-shaped clamp (296) relative to the frame (302).

8. The switch assembly (104, 204) as claimed in claim 4, wherein the second bracket (142) comprises:
a frame (180) having the second lock (182); and
a coupler (184) of the second lock (182) extending outwardly from the frame (180), the coupler (184) comprising:
a first arm (186);
a second arm (188) disposed parallel and spaced apart from the first arm (186), wherein the first arm (186) and the second arm (188) are joined along a respective first ends (190) and are disposed spaced apart along respective opposite ends (192); and
a central portion (194) defining an opening extending between the first arm (186) and the second arm (188) to facilitate the resting of the neck portion (172) of the pin clamp (170), wherein the two arms (186, 188) are separated to unlock the pin clamp (170).

9. The switch assembly (104, 204) as claimed in claim 1, wherein the first bracket (140) and the second bracket (142, 242) are integrated to the first portion (110).

10. The switch assembly (104, 204) as claimed in claim 1, wherein the first bracket (140) and the second bracket (142, 242) are fastened to the first portion (110).
